(19) United States
(12) Patent Application Publication
(10) Pub. No.: US 2024/0414575 A1
(43) Pub. Date: Dec. 12, 2024

(54) PRESERVING NETWORK CAPACITY AT AN EVENT

(71) Applicant: T-MOBILE INNOVATIONS LLC, Overland Park, KS (US)

(72) Inventor: Bhagwan Singh KHANKA, Las Vegas, NV (US)

(21) Appl. No.: 18/206,330

(22) Filed: Jun. 6, 2023

(51) Int. Cl. H04W 24/10; H04W 56/00

(52) U.S. Cl. CPC H04W 24/10; H04W 56/001

(57) ABSTRACT

Methods and systems for preserving network capacity by successively sharing content serially using an event protocol are provided. The method begins with monitoring the RF signal conditions for user devices at an event. A first user device with RF signal conditions above a threshold is identified. A second user device within a predetermined distance from the first user device and is within predetermined RF signal conditions is also identified. The second user device is requesting a download of the same content as the first device. The first and second user devices are synchronized using an event protocol. The event protocol may automatically perform the synchronization and may use a handshaking protocol as part of the synchronization process. Once the event synchronization is complete the first device transmits the content to the second device. The synchronizing may be repeated with successive user devices to serially deliver the common content to the successive user devices at the event.

### BACKGROUND

Mobile device users may attend a sporting game, concert, or other large gathering and may want to view replays and video from segments of the event that a user might not see from their seat. In addition, there may be video content available at the event for users to download while attending that may enhance the fan experience. These situations may lead to multiple users attempting to download or watch the same content. Typically, this scenario may be implemented by having each user use separate network resources to download the data. Alternatively, the data may be sent over a common channel. Neither implementation provides for efficient use of network capacity and may not effectively serve the number of users needed. Users may have a negative customer experience as the network performance may be degraded. Furthermore, the common channel cannot be adjusted for power or modulation based on each user's location and network connection, which may also adversely affect the user experience.

### SUMMARY

A high-level overview of various aspects of the present technology is provided in this section to introduce a selection of concepts that are further described below in the detailed description section of this disclosure. This summary is not intended to identify key or essential features of the claimed subject matter, nor is it intended to be used as an aid in isolation to determine the scope of the claimed subject matter.

According to aspects herein, methods and systems for preserving network capacity by successively sharing content serially using an event protocol are provided. The methods and systems preserve network capacity by serially sharing content from user device to user device based on nearness of the next device to share the content. A method begins with monitoring the RF signal conditions for user devices at an event. A first user device with RF signal conditions above a threshold is identified. A second user device that is within a predetermined distance from the first user device and that is within predetermined RF conditions is also identified. The second user device is requesting a download of the same content as the first device.

The first and second user devices are synchronized using an event protocol. The event protocol may automatically perform the synchronization and may use a handshaking protocol as part of the synchronization process. Once the event synchronization is complete the first device transmits the content to the second device. The synchronizing may be repeated with successive user devices to serially deliver the common content to the successive user devices at the event.

### BRIEF DESCRIPTION OF THE SEVERAL VIEWS OF THE DRAWINGS

Implementations of the present disclosure are described in detail below with reference to the attached drawing figures, wherein:

FIG. 1 depicts a diagram of an exemplary network environment in which implementations of the present disclosure may be employed, in accordance with aspects herein;

FIG. 2 depicts a cellular network suitable for use in implementations of the present disclosure, in accordance with aspects herein;

FIG. 3 depicts a flow diagram of an exemplary method for preserving network capacity at an event in a network, in accordance with aspects herein; and

FIG. 4 depicts an exemplary computing device suitable for use in implementations of the present disclosure, in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. The following is a list of these acronyms:
3G Third-Generation Wireless Technology
4G Fourth-Generation Cellular Communication System
5G Fifth-Generation Cellular Communication System
6G Sixth-Generation Cellular Communication System
AI Artificial Intelligence
CD-ROM Compact Disk Read Only Memory
CDMA Code Division Multiple Access
eNodeB Evolved Node B
GIS Geographic/Geographical/Geospatial Information System
gNodeB Next Generation Node B
GPRS General Packet Radio Service
GSM Global System for Mobile communications
iDEN Integrated Digital Enhanced Network
DVD Digital Versatile Discs
EEPROM Electrically Erasable Programmable Read Only Memory
LED Light Emitting Diode
LTE Long Term Evolution
MIMO Multiple Input Multiple Output
MD Mobile Device
ML Machine Learning
PC Personal Computer
PCS Personal Communications Service
PDA Personal Digital Assistant
PDSCH Physical Downlink Shared Channel
PHICH Physical Hybrid ARQ Indicator Channel
PUCCH Physical Uplink Control Channel
PUSCH Physical Uplink Shared Channel
RAM Random Access Memory
RET Remote Electrical Tilt
RF Radio-Frequency
RFI Radio-Frequency Interference
R/N Relay Node
RNR Reverse Noise Rise
ROM Read Only Memory
RSRP Reference Signal Receive Power
RSRQ Reference Signal Receive Quality
RSSI Received Signal Strength Indicator
SINR Transmission-to-Interference-Plus-Noise Ratio
SNR Transmission-to-noise ratio
SON Self-Organizing Networks
TDMA Time Division Multiple Access
TXRU Transceiver (or Transceiver Unit)
UE User Equipment
UMTS Universal Mobile Telecommunications Systems
WCD Wireless Communication Device (interchangeable with UE)

Further, various technical terms are used throughout this description. An illustrative resource that fleshes out various aspects of these terms can be found in Newton's Telecom Dictionary, 32^{nd} Edition (2022).

Embodiments of the present technology may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, a traditional telecommunications network employs a plurality of access points (i.e., access point, node, cell sites, cell towers) to provide network coverage. The access points are employed to broadcast and transmit transmissions to user devices of the telecommunications network. An access point may be considered to be a portion of an access point that may comprise an antenna, a radio, and/or a controller. In aspects, an access point is defined by its ability to communicate with a user equipment (UE), such as a wireless communication device (WCD), according to a single protocol (e.g., 3G, 4G, LTE, 5G, and the like); however, in other aspects, a single access point may communicate with a UE according to multiple protocols. As used herein, an access point may comprise one access point or more than one access point. Factors that can affect the telecommunications transmission include, e.g., location and size of the access points, and frequency of the transmission, among other factors. The access points are employed to broadcast and transmit transmissions to user devices of the telecommunications network. Traditionally, the access point establishes uplink (or downlink) transmission with a mobile handset over a single frequency that is exclusive to that particular uplink connection (e.g., an LTE connection with an EnodeB). The access point may include one or more sectors served by individual transmitting/receiving components associated with the access point (e.g., antenna arrays controlled by an EnodeB). These transmitting/receiving components together form a multi-sector broadcast arc for communication with mobile handsets linked to the access point.

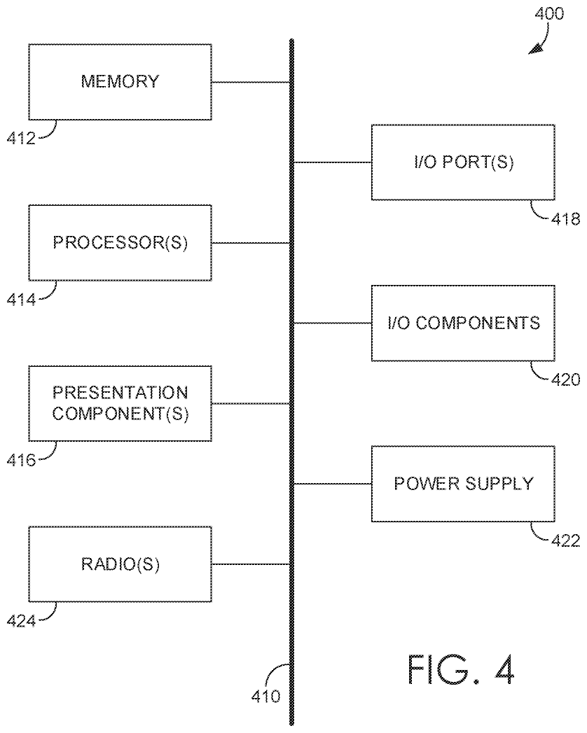

As used herein, “access point” is one or more transmitters or receivers or a combination of transmitters and receivers, including the accessory equipment, necessary at one location for providing a service involving the transmission, emission, and/or reception of radio waves for one or more specific telecommunication purposes to a mobile station (e.g., a UE). The term/abbreviation UE (also referenced herein as a user device or wireless communications device (WCD)) can include any device employed by an end-user to communicate with a telecommunications network, such as a wireless telecommunications network. A UE can include a mobile device, a mobile broadband adapter, or any other communications device employed to communicate with the wireless telecommunications network. A UE, as one of ordinary skill in the art may appreciate, generally includes one or more antennas coupled to a radio for exchanging (e.g., transmitting and receiving) transmissions with a nearby access point. A UE may be, in an embodiment, similar to device 400 described herein with respect to FIG. 4.

As used herein, UE (also referenced herein as a user device or a wireless communication device) can include any device employed by an end-user to communicate with a wireless telecommunications network. A UE can include a mobile device, a mobile broadband adapter, a fixed location or temporarily fixed location device, or any other communications device employed to communicate with the wireless telecommunications network. For an illustrative example, a UE can include cell phones, smartphones, tablets, laptops, small cell network devices (such as micro cell, pico cell, femto cell, or similar devices), and so forth. Further, a UE can include a sensor or set of sensors coupled with any other communications device employed to communicate with the wireless telecommunications network; such as, but not limited to, a camera, a weather sensor (such as a rain gage, pressure sensor, thermometer, hygrometer, and so on), a motion detector, or any other sensor or combination of sensors. A UE, as one of ordinary skill in the art may appreciate, generally includes one or more antennas coupled to a radio for exchanging (e.g., transmitting and receiving) transmissions with a nearby access point or access point.

In aspects, a UE provides UE data including location and channel quality information to the wireless communication network via the access point. Location information may be based on a current or last known position utilizing GPS or other satellite location services, terrestrial triangulation, an access point's physical location, or any other means of obtaining coarse or fine location information. Channel quality information may indicate a realized uplink and/or downlink transmission data rate, observed signal-to-interference-plus-noise ratio (SINR), reference signal received quality (RSRQ), and/or signal strength at the user device, or throughput of the connection. Channel quality information may be provided via, for example, an uplink pilot time slot, downlink pilot time slot, sounding reference signal, channel quality indicator (CQI), rank indicator, precoding matrix indicator, or some combination thereof. Channel quality information may be determined to be satisfactory or unsatisfactory, for example, based on exceeding or being less than a threshold. Location and channel quality information may take into account the user device capability, such as the number of antennas and the type of receiver used for detection. Processing of location and channel quality information may be done locally, at the access point or at the individual antenna array of the access point. In other aspects, the processing of said information may be done remotely.

The UE data may be collected at predetermined time intervals measured in milliseconds, seconds, minutes, hours, or days. Alternatively, the UE data may be collected continuously. The UE data may be stored at a storage device of the UE, and may be retrievable by the UE's primary provider as needed and/or the UE data may be stored in a cloud based storage database and may be retrievable by the UE's primary provider as needed. When the UE data is stored in the cloud based storage database, the data may be stored in association with a data identifier mapping the UE data back to the UE, or alternatively, the UE data may be collected without an identifier for anonymity.

A first aspect of the present disclosure provides a method for preserving network capacity at an event in a network. The method begins with monitoring RF signal conditions for user devices at an event. Based on the RF signal condition reports sent by the user devices, a first user device is identified. The first user device has requested content and has RF signal conditions above a threshold. A second user device is then identified. The second user device is within a predetermined distance from the first user device, is within predetermined RF conditions, and is requesting a download of the same content requested by the first user device. The first and second user device are then synchronized using an event protocol. Synchronizing allows the first user to device to transmit the content to the second user device. The content is then transmitted from the first user device to the second user device. The synchronizing process may then be repeated, using the event protocol with successive user devices to serially deliver the content to the successive user devices at the event.

A second aspect of the present disclosure provide a system for preserving network capacity at an event in a network. The system includes at least one processor in communication with a non-transitory computer-readable media storing computer useable instructions. The access point also comprises an RF condition module that is configured to receive RF signal condition reports from user devices at the event. The access point further comprises an event protocol module that is configured to instruct a first user device to synchronize with a second user device using an event protocol and to share common content requested by both the first user device and the second user device directly from the first user device to the second user device.

Another aspect of the present disclosure is directed to a non-transitory computer storage media storing computer-usable instructions that cause the processors to monitor RF signal conditions for user devices at an event. Based on the RF signal condition reports sent by the user devices at the event, the processors identify a first user device that has requested content and has RF signal conditions above a threshold. The processors then identify a second user device that is within a predetermined distance from the first user device, is within predetermined RF conditions, and that is requesting a download of the content requested by the first user device. The instructions then synchronize the first device and the second user device using an event protocol. Synchronizing allows the second user device to receive the content from the first user device. The content may then be transmitted from the first user device to the second user device. The synchronizing process may be repeated using the event protocol with successive user devices to serially deliver the content to the successive user devices at the event.

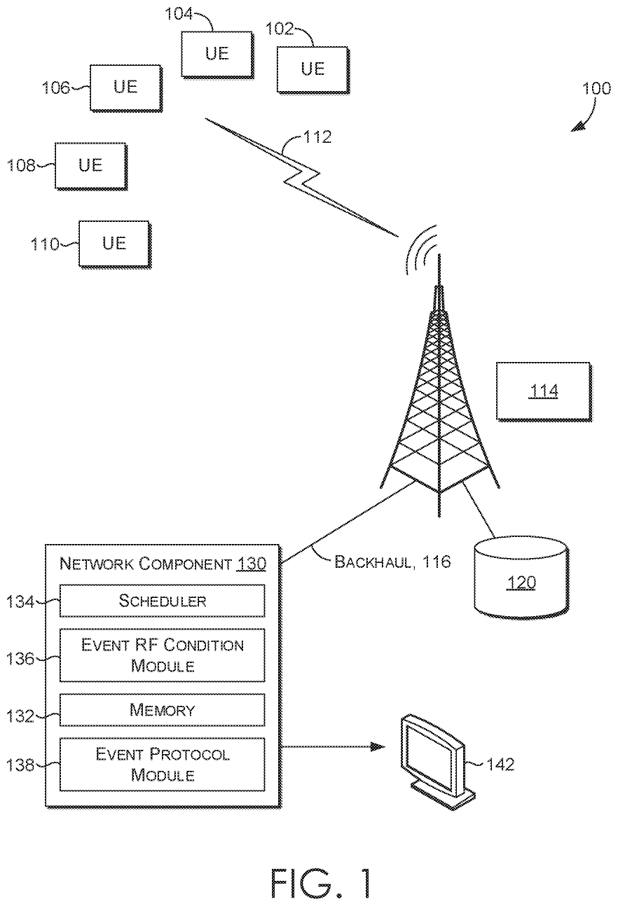

FIG. 1 illustrates an example of a network environment 100 suitable for use in implementing embodiments of the present disclosure. The network environment 100 is but one example of a suitable network environment and is not intended to suggest any limitation as to the scope of use or functionality of the disclosure. Neither should the network environment 100 be interpreted as having any dependency or requirement to any one or combination of components illustrated.

Network environment 100 includes user devices (UE) 102, 104, 106, 108, and 110, access point 114 (which may be a cell site, access point, or the like), and one or more communication channels 112. The UEs 102, 104, 106, 108, and 110 may be attending an event such as a sporting event or concert where a large number of UEs may be operating. The event may include many more UEs than 102, 104, 106, 108, and 110 that are served by the network environment 100. The communication channels 112 can communicate over frequency bands assigned to the carrier. In network environment 100, user devices may take on a variety of forms, such as a personal computer (PC), a user device, a smart phone, a smart watch, a laptop computer, a mobile phone, a mobile device, a tablet computer, a wearable computer, a personal digital assistant (PDA), a server, a CD player, an MP3 player, a global positioning system (GPS) device, a video player, a handheld communications device, a workstation, a router, a hotspot, and any combination of these delineated devices, or any other device (such as the computing device 400) that communicates via wireless communications with the access point 114 in order to interact with a public or private network.

In some aspects, each of the UEs 102, 104, 106, 108, and 110 may correspond to computing device 400 in FIG. 4. Thus, a UE can include, for example, a display(s), a power source(s) (e.g., a battery), a data store(s), a speaker(s), memory, a buffer(s), a radio(s) and the like. In some implementations, for example, a UEs 102, 104, 106, 108, and 110 comprise a wireless or mobile device with which a wireless telecommunication network(s) can be utilized for communication (e.g., voice and/or data communication). In this regard, the user device can be any mobile computing device that communicates by way of a wireless network, for example, a 3G, 4G, 5G, 6G, LTE, CDMA, or any other type of network. In some cases, UEs 102, 104, 106, 108, and 110 in network environment 100 can optionally utilize one or more communication channels 112 to communicate with other computing devices (e.g., a mobile device(s), a server(s), a personal computer(s), etc.) through access point 114.

The network environment 100 may be comprised of a telecommunications network(s), or a portion thereof. A telecommunications network might include an array of devices or components (e.g., one or more access points), some of which are not shown. Those devices or components may form network environments similar to what is shown in FIG. 1, and may also perform methods in accordance with the present disclosure. Components such as terminals, links, and nodes (as well as other components) can provide connectivity in various implementations. Network environment 100 can include multiple networks, as well as being a network of networks, but is shown in more simple form so as to not obscure other aspects of the present disclosure. Network environment 100 may comprise equipment placed in network operator facilities, but may also comprise equipment located at a customer's premises, known as customer premises equipment (CPE).

The one or more communication channels 112 can be part of a telecommunication network that connects subscribers to their immediate telecommunications service provider (i.e., home network carrier). In some instances, the one or more communication channels 112 can be associated with a telecommunications provider that provides services (e.g., 3G network, 4G network, LTE network, 5G network, 6G, and the like) to user devices, such as UEs 102, 104, 106, 108, and 110. For example, the one or more communication channels may provide voice, SMS, and/or data services to UEs 102, 104, 106, 108, and 110, or corresponding users that are registered or subscribed to utilize the services provided by the telecommunications service provider. The one or more communication channels 112 can comprise, for example, a 1× circuit voice, a 3G network (e.g., CDMA, CDMA2000, WCDMA, GSM, UMTS), a 4G network (WiMAX, LTE, HSDPA), or a 5G network or a 6G network.

In some implementations, access point 114 is configured to communicate with a UE, such as UEs 102, 104, 106, 108, and 110, that are located within the geographic area, or cell, covered by radio antennas of access point 114. Access point 114 may serve an area such as a stadium or concert venue where large numbers of UEs may be served. Access point 114 may include one or more access points, base transmitter stations, radios, antennas, antenna arrays, power amplifiers, transmitters/receivers, digital signal processors, control electronics, GPS equipment, and the like.

As shown, access point 114 is in communication with a network component 130 and at least a network database 120 via a backhaul channel 116. As the UEs 102, 104, 106, 108, and 110 collect individual signal information, the signal information can be automatically communicated by each of the UEs 102, 104, 106, 108, and 110 to the access point 114. Access point 114 may store the signal information and data communicated by the UEs 102, 104, 106, 108, and 110 at a network database 120. Alternatively, the access point 114 may automatically retrieve the status data from the UEs 102, 104, 106, 108, and 110, and similarly store the data in the network database 120. The signal information and data may be communicated or retrieved and stored periodically within a predetermined time interval which may be in seconds, minutes, hours, days, months, years, and the like. The signal information may also be collected during a period designated as an event period with a duration of the length of a designated event. The event may last for a predetermined period of time with the duration coinciding with the length of a sporting event or concert. The event may occur over multiple days with a different predetermined duration for each day and with a different event period for each day. With the incoming of new data, the network database 120 may be refreshed with the new data every time, or within a predetermined time threshold so as to keep the status data stored in the network database 120 current. For example, the data may be received at or retrieved by the access point 114 every 10 minutes and the data stored at the network database 120 may be kept current for 30 days, which means that status data that is older than 30 days would be replaced by newer status data at 10 minute intervals. As described above, the status data collected by the UEs 102, 104, 106, 108, and 110 can include, for example, service state status, the respective UE's current geographic location, a current time, a strength of the wireless signal, available networks, and the like.

The network component 130 comprises a memory 132, a scheduler 134, an event RF condition module 136, and a handshake module 138. All determinations, calculations, and data further generated by the scheduler 134, event RF condition module 136, and handshake module 138 may be stored at the memory 132 and also at the data store 140. Although the network component 130 is shown as a single component comprising the memory 132, scheduler 134, event RF condition module 136, handshake module 138, and the data store 140, it is also contemplated that each of the memory 132, the scheduler 134, the event RF condition module 136, and the handshake module 138, may reside at different locations, be its own separate entity, and the like, within the home network carrier system.

The network component 130 is configured to retrieve signal quality metrics and carrier loading metrics from the access point 114 or one of the UEs, 102, 104, 106, 108, and 110. Signal quality metrics can include any one or more of multiple metrics, such as signal-to-interference and noise (SINR), reference signal received power (RSRP), and reference signal received quality (RSRQ). The network component 130 can also track uplink and downlink user traffic. The scheduler 134 can observe data usage on at least one common channel over the network using measurement metrics such as SINR, RSRP, and RSRQ. The scheduler 134, the event RF condition module 136, and the handshake module 138 may each be located in a central office or other centralized location, but may also be mounted on an access point at or near the event location. For a distributed radio access network, the scheduler 134 can be located at the access point 114. The scheduler 134, acting in conjunction with the event RF condition module 136 and the handshake module 138 may then ensure that the UEs 102, 104, 106, 108, and 110, receive event network services.

Common channel signaling is the transmission of control information using a separate channel from that used for messages or data. The control channel may control multiple message or data channels. A control channel may be serially repeated to serve users at an even in a stadium or arena. The user device with the best RF conditions in the stadium or arena is determined. Determining the best RF conditions may use signal condition reports sent to the network by each user device active at the event. The signal condition reports from each user device may use signal condition metrics including SINR, RSRQ, RSRP, signal strength, and throughput.

Once the user device with the best RF conditions has been determined, a handshake is performed with a next user device that is close to the user device with the best RF conditions. Handshaking is an automated negotiation process between two user devices through the exchange of information that establishes the protocols of a communication link at the start of the communication before normal communication begins. After the handshake is complete the download of the user device with the best RF conditions, which may also be known as the first user device, is downloaded by the close user device, which may also be known as the second user device. Because the first user device and the second user device are close to one another only low power is needed for the transmission. This process may be repeated to serially repeat the common channel to a third user device, fourth user device, and so on through the user devices served by the network provider at the event.

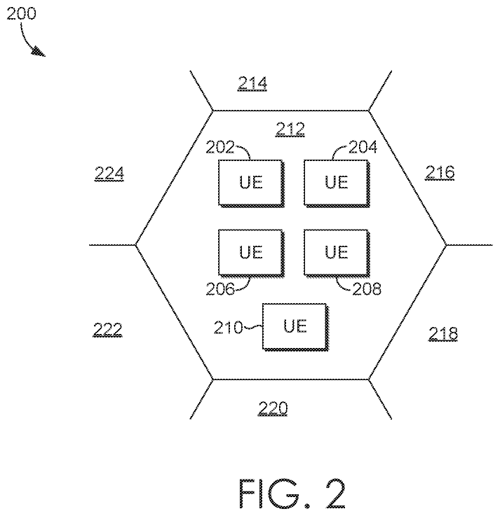

FIG. 2 depicts a cellular network suitable for use in implementations of the present disclosure, in accordance with aspects herein. For example, as shown in FIG. 2, each geographic area in the plurality of geographic areas may have a hexagonal shape such as hexagon representing a geographic area 200 having cell sites 212, 214, 216, 218, 220, 222, 224, each including access point 114, backhaul channel 116, antenna for sending and receiving signals over communication channels 112, network database 120 and network component 130. The size of the geographic area 200 may be predetermined based on a level of granularity, detail, and/or accuracy desired for the determinations/calculations done by the systems, computerized methods, and computer-storage media. A plurality of UEs may be located within each geographic area collecting UE data within the geographic area at a given time. For example, as shown in FIG. 2, UEs 202, 204, 206, 208, and 210, may be located within geographic area 200 collecting UE data that is useable by network component 130, in accordance with aspects herein. UEs 202, 204, 206, 208, and 210 can move within the cell currently occupying, such as cell site 212 and can move to other cells such as adjoining cell sites 214, 216, 218, 220, 222 and 224.

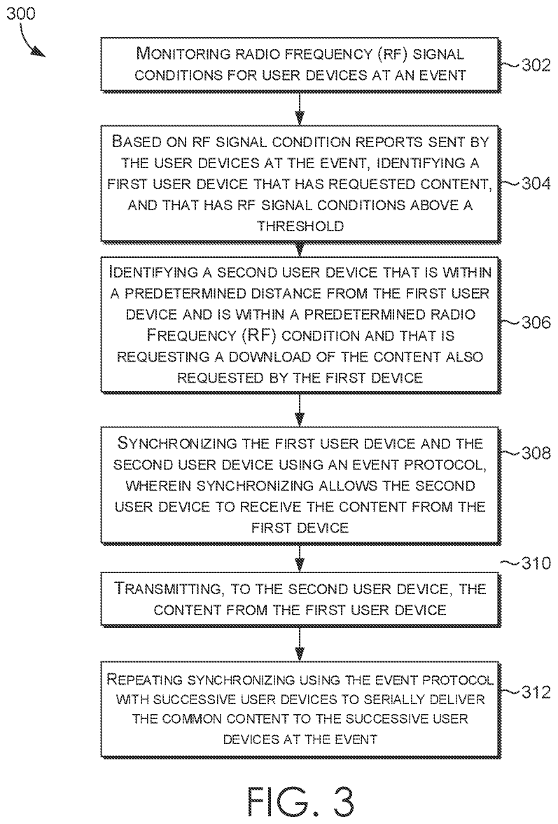

FIG. 3 depicts a flow diagram of an exemplary method for preserving network capacity at an event in a network, in accordance with aspects herein. The method 300, begins in step 302 with monitoring RF signal condition reports for user devices at an event. The method then continues in step 304 with identifying a first user device that has requested content, and that has RF signal conditions above a threshold. Then in step 306 a second user device that is within a predetermined distance from the first user device and is within a predetermined RF condition and that is requesting a download of the content also requested by the first user device is identified. The first user device may be near the second user device physically or near in terms of RF signal conditions and amount of transmit power needed to synchronize and share content.

Next, in step 308 the method continues with synchronizing the first user device and the second user device using an event protocol. The synchronizing allows the second user device to receive the content from the first user device. Then in step 310 the method continues with transmitting, to the second user device, content from the first user device. The method concludes in step 312 with repeating synchronizing using the event protocol with successive user devices to serially deliver the common content to the successive user devices at the event.

The content requested by the first user device and the second user device may be determined using deep packet inspection of the requests made by the user devices. The first user device may receive the common content over dedicated network resources. The dedicated network resources may be a common channel. The synchronization of the first and second user devices may occur for the duration of the common content or the event. The first device may terminate the download of the common content, in which case the second user device may be synchronized with another user device. The event protocol may use a handshaking operation as part of the synchronization process.

Once synchronized the event protocol sets the second user device to uplink with the first user device. As part of the synchronization process, the second user device must affirmatively respond to a synchronization request sent as part of the event protocol. The second user device may be notified if the first user device terminates the download. The user device to synchronize with may be determined in part by location and also by available power. The available power may limit how far the first user device may transmit to the second user device. The common content shared from the first user device to the second user device may be encapsulated to protect the privacy of the first user device. The event may limit serial sharing of common content when a predetermined number of devices at the event are sharing content. The predetermined number of devices may represent a congestion value, such as 80%. The common content may be encapsulated when shared between user devices.

FIG. 4 depicts an exemplary computing device suitable for use in implementations of the present disclosure, in accordance with aspects herein. With continued reference to FIG. 4, computing device 400 includes bus 410 that directly or indirectly couples the following devices: memory 412, one or more processors 414, one or more presentation components 416, input/output (I/O) ports 418, I/O components 420, radio(s) 424, and power supply 422. Bus 410 represents what may be one or more busses (such as an address bus, data bus, or combination thereof). Although the devices of FIG. 4 are shown with lines for the sake of clarity, in reality, delineating various components is not so clear, and metaphorically, the lines would more accurately be grey and fuzzy. For example, one may consider a presentation component such as a display device to be one of I/O components 420. Also, processors, such as one or more processors 414, have memory. The present disclosure hereof recognizes that such is the nature of the art, and reiterates that FIG. 4 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 4 and refer to “computer” or “computing device.”

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

Computing device 400 typically includes a variety of computer-readable media. Computer-readable media can be any available media that can be accessed by computing device 400 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 412 includes computer-storage media in the form of volatile and/or nonvolatile memory. Memory 412 may be removable, nonremovable, or a combination thereof. Exemplary memory includes solid-state memory, hard drives, optical-disc drives, etc. Computing device 400 includes one or more processors 406 that read data from various entities such as bus 410, memory 412 or I/O components 420. One or more presentation components 416 present data indications to a person or other device. Exemplary one or more presentation components 416 include a display device, speaker, printing component, vibrating component, etc. I/O ports 418 allow computing device 400 to be logically coupled to other devices including I/O components 420, some of which may be built into computing device 400. Illustrative I/O components 420 include a microphone, joystick, game pad, satellite dish, scanner, printer, wireless device, etc.

The radio(s) 424 represents one or more radios that facilitate communication with a wireless telecommunications network. While a single radio 424 is shown in FIG. 4, it is contemplated that there may be more than one radio 424 coupled to the bus 410. Illustrative wireless telecommunications technologies include CDMA, GPRS, TDMA, GSM, and the like. The radio 424 may additionally or alternatively facilitate other types of wireless communications including Wi-Fi, WiMAX, LTE, 3G, 4G, LTE, 5G, NR, VOLTE, or other VoIP communications. As can be appreciated, in various embodiments, radio 424 can be configured to support multiple technologies and/or multiple radios can be utilized to support multiple technologies. A wireless telecommunications network might include an array of devices, which are not shown so as to not obscure more relevant aspects of the invention. Components such as a access point, a communications tower, or even access points (as well as other components) can provide wireless connectivity in some embodiments.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. A method for preserving network capacity in a network, the method comprising:
monitoring radio frequency (RF) signal conditions for user devices at an event;
based on RF signal condition reports sent by the user devices at the event, identifying a first user device that has requested content, and that has RF signal conditions above a threshold;
identifying a second user device that is within a predetermined distance from the first user device and is within a predetermined radio frequency (RF) condition and that is requesting a download of the content also requested by the first user device;
synchronizing the first user device and the second user device using an event protocol, wherein synchronizing allows the second user device to receive the content from the first user device;
transmitting, to the second user device, the content from the first user device; and
repeating synchronizing using the event protocol with successive user devices to serially deliver the content to the successive user devices at the event.

2. The method of claim 1, wherein the content is determined using deep packet inspection of the requests made by the first user device and the second user device.

3. The method of claim 1, wherein the first user device receives the content over dedicated network resources.

4. The method of claim 1, wherein synchronizing the first user device and the second user device occurs for a duration of a download of the content.

5. The method of claim 4, wherein the duration of synchronization is a duration of the event.

6. The method of claim 1, further comprising terminating the download of the content when requested by the first user device.

7. The method of claim 1, wherein the event is one of a recurring series of events.

8. The method of claim 1, wherein the common content is limited to network subscribers.

9. The method of claim 1, wherein the event protocol comprises handshaking operations between the first user device and the second user device.

10. A system for preserving network capacity at an event in a network, comprising:
an access point comprising:
at least one processor in communication with non-transitory computer-readable media storing computer useable instructions;
an event radio frequency (RF) condition module configured to receive RF signal condition reports from user devices at the event; and
an event protocol module configured to instruct a first user device to synchronize with a second user device using an event protocol and to share content requested by both the first user device and the second user device where the first user device communicates the content directly to the second user device.

11. The system of claim 10, wherein the second user device is located within a predetermined distance from the first user device and is within a predetermined radio RF condition.

12. The system of claim 10, wherein the event protocol module is configured to instruct the second user device to repeat the handshaking operation with a third user device.

13. The system of claim 10, wherein share the content from the at least one first user device with the least one second user device occurs for the duration of the event.

14. The system of claim 13, wherein the duration of the event is predetermined by a network operator.

15. The system of claim 13, wherein the event is one of a recurring series of events.

16. A non-transitory computer storage media storing computer-usable instructions that, when used by one or more processors, cause the processor to:
monitor radio frequency (RF) signal conditions for user devices at an event;
based on RF signal condition reports sent by the user devices at the event, identifying a first user device that has requested content and that has RF signal conditions above a threshold;
identify a second user device that is within a predetermined distance from the first user device and is within predetermined RF conditions and that is requesting a download of the content also requested by the first user device;
synchronize the first user device and the second user device using an event protocol, wherein synchronizing allows the second user device to receive the content from the first user device;
transmit to the second user device, the content from the first user device; and
repeating synchronizing using the event protocol with successive user devices to serially deliver the content to the successive user devices at the event.

17. The non-transitory computer storage media of claim 16, wherein the content is determined using deep packet inspection of the requests made by the first user device and the second user device.

18. The non-transitory computer storage media of claim 16, wherein the first user device receives the common content over dedicated network resources.

19. The non-transitory computer storage media of claim 16, wherein synchronize the first user device and the second user device occurs for a duration of a download of the content.

20. The non-transitory computer storage media of claim 16, wherein the content is related to the event.
